(19) United States
(12) Patent Application Publication
(10) Pub. No.: US 2019/0390430 A1
(43) Pub. Date: Dec. 26, 2019

(54) PENETRATION TESTING APPARATUS

(71) Applicant: CRP Developments Limited, Auckland (NZ)

(72) Inventors: Stacy Lee Goldsworthy, Auckland (NZ); Jason Charles Gordon Stamp, Cambridge (NZ); Danny Robert Wyatt, Hamilton (NZ); Gavin Richard Miller, Auckland (NZ)

(73) Assignee: CRP Developments Limited, Auckland (NZ)

(21) Appl. No.: 16/465,334

(22) PCT Filed: Nov. 28, 2017
(86) PCT No.: PCT/NZ2017/050151

§ 371 Date: May 30, 2019

(30) Foreign Application Priority Data
Dec. 1, 2016 (NZ) 726993

(51) Int. Cl. E02D 1/02; G01N 3/42; E21B 7/02

(52) U.S. Cl. CPC E02D 1/022; E02D 1/025; E21B 7/027; G01N 3/42

(57) ABSTRACT

A penetration testing apparatus for testing the bearing strength of ground, soil layers, base-courses, subbases and subgrades without the need for much manual operation, includes the following components operatively connected together, comprising a frame support (5) which supports an actuating apparatus (7), power supply apparatus (9), movable carriage assembly (13), ground penetrating member (15), carriage drive mechanism 17 and ground stabilizing means (18), operatively connected together to carry out a ground test. The movable carriage assembly (13) movably supports one ground penetrating member (15). The movable carriage assembly (13) is movably supported by the frame support (5) such that power from the actuating apparatus (7) slidably and mechanically moves the carriage assembly (13) up and down with the ground penetrating member (15), on a portion of the frame support (5), to cause the ground penetrating member (15) to contact or penetrate the ground when the carriage assembly (13) moves down and be slidably moved back up the portion of the frame support (5) to repeat the sliding down movement again.

The present invention relates to a penetration testing apparatus for testing the bearing strength of ground, soil layers, base-courses, subbases and subgrades without the need for manual operation. The invention is directed particularly but not solely towards a penetration testing apparatus having a mechanical operation without manual operation that can be removably attached to a support apparatus such as a vehicle and be non-manually and mechanically operated.

### BACKGROUND OF INVENTION

Penetration testing apparatus are commonly used for many years by engineering staff to determine the strength of ground for the location of an engineered structure. These apparatus are part of a system devised consisting of standard apparatus that can cope with different ground types to determine the load bearing capacities of any soil types used for supporting engineering structures such as for example buildings and roads.

Current systems were developed to ensure that there was a simple system that could be consistently operated without complication with standard equipment to ensure meaningful and useful results were achieved. However using current systems has meant using cumbersome and heavy equipment that requires several staff members to transport, set up and operate. The heavy equipment includes a steel penetrating rod and slidably movable heavy weight.

Because the current systems are so heavy they can be very difficult to move over rough terrain to remote locations. Furthermore existing systems require strength to operate which can be tiring to use especially when operating over many sites or test locations. The heavy equipment can provide an ongoing hazard to staff during set up and operation which can compromise the efficacy of the results if for example the heavy weight is not properly lifted to a correct height and dropped correctly and consistently.

All of these factors add significant costs to projects including staff wages, potential accidents including serious harm and length of time needed to carry out all testing.

In this specification unless the contrary is expressly stated, where a document, act or item of knowledge is referred to or discussed, this reference or discussion is not an admission that the document, act or item of knowledge or any combination thereof was at the priority date, publicly available, known to the public, part of common general knowledge; or known to be relevant to an attempt to solve any problem with which this specification is concerned.

### OBJECT OF THE INVENTION

It is an object of the invention to provide an improved penetration testing apparatus that ameliorates some of the disadvantages and limitations of the known art or at least provides the public with a useful choice. The apparatus provides an alternative choice that negates much of the manual handling involved with current testing apparatus.

### SUMMARY OF INVENTION

A penetration testing apparatus for testing the bearing strength of ground, soil layers, base-courses, subbases and subgrades without the need for much manual operation, including the following components operatively connected together, comprising a frame support 5 which supports an actuating apparatus 7, power supply apparatus 9, movable carriage assembly 13, ground penetrating member 15, carriage drive mechanism 17 and ground stabilizing means 18, operatively connected together to carry out a ground test, wherein the movable carriage assembly 13 movably supports the ground penetrating member 15 wherein the movable carriage assembly 13 is movably supported by the frame support 5 such that power from the actuating apparatus 7 slidably and mechanically moves the carriage assembly 13 up and down with the ground penetrating member 15, on a portion of the frame support 5, to cause the ground penetrating member 15 to contact or penetrate the ground when the carriage assembly 13 moves down and be slidably moved back up the portion of the frame support 5 to repeat the sliding down movement again.

Preferably, the frame support 5 includes a base support frame 20 comprising a planar frame horizontally oriented which supports a mast frame 21 which is vertically oriented.

Preferably the carriage assembly 13 includes a carriage slidably mounted on the mast frame 21 whereby in use the carriage drive mechanism 17 enables the carriage assembly to move up and down the mast frame 21.

Preferably the actuating apparatus 7 is located and supported on the base support frame 20 on one side of the mast frame 21, with the power supply apparatus 9 being located on the other side of the mast frame 21, also being located on the base support frame 20.

Preferably the apparatus includes ground stabilizing means 18 which comprise at least one hydraulic ram assembly which includes a leg ram member 55 slidably received in a tubular ram receiving member 56, which is located and supported on the base support frame 20 and being operatively connected by the actuating apparatus 7 to in use cause each leg ram member 55 to downwardly extend to engage or abut a supporting surface (eg the ground) to support and level the apparatus, the purpose of which is to allow the vehicle to be raised which in turn allows its mass to be utilised to push ground penetrating member 15 wherein a seating ram member 60 is adjustable and connected underneath to cantilevered support member 50 of the support frame 20, to ensure that the mast frame 21 when set up to conduct a test is perpendicular to the ground subject to test or at an angle as required by the operator.

Preferably the actuating apparatus is a hydraulic actuating apparatus.

Preferably the actuating apparatus 7 includes an electric motor 70 operatively connected to the power supply apparatus 9 and the electric motor 70 is operatively connected to a hydraulic pump 72 and then to a hydraulic tank 71 and levers 74 to activate hydraulic lines 58 which are connected to the carriage assembly 13.

Preferably the electric motor 70, the tank 71, and the pump 72 are located within an actuating housing.

Preferably the actuating apparatus 7 self cycles when in the on position whereby flow of hydraulic fluid is controlled through each of the rams 18, 19 and the hydraulic motor 106 by the levers 74 which include levers 111,112,113,114, 115 and 116.

Preferably the mast frame 21 is an elongate frame having ends, comprising side members 35 connected to cross members including plate members 36 located at the ends and moveable mounted rod members 42 located in between the ends and between the sides members 35 wherein the rod members 42 include movable wheel cog members 44.

Preferably the carriage drive mechanism 17 includes a flexible drive member including a chain link member movably mounted on the cog wheel members 44 within the mast frame 21.

Preferably the carriage assembly 13 includes a carriage motor 106 which is operatively provided and located on the carriage assembly 13 to cause the ground penetrating member 15 to rotate.

Preferably the carriage assembly 13 includes a front plate member 100, a spacer member 104 and rear plate member 102 together forming a member having side channels for sliding receipt in the side members 35 of the mast support 21.

Alternatively, the actuating apparatus is an electrical actuating apparatus comprising an electric motor operatively connected to the rest of the components of the apparatus wherein the components are all electrical equivalents including linear actuators, electric switches, electric motors and drive units wherein the linear actuators each have an electric motor connected to power supply 9.

Alternatively, the actuating apparatus is a pneumatic actuating apparatus comprising an electric motor 70 operatively connected to the rest of the components of the apparatus.

Preferably the power supply apparatus 9 includes at least one battery 82 located inside a power supply housing, additional batteries may be stored on the vehicle to which the apparatus is attached.

Preferably the power supply apparatus 9 includes an on/off switch 92 and E stop 93 which are operative connected to the battery 82 wherein the on/off switch 92 controls the supply of power to the electric motor 70 and the E stop 93 functions to provide a safety cut out mechanism if required.

Preferably the carriage drive mechanism 17 includes a mast ram apparatus 19 which is operatively connected to the hydraulic actuating apparatus 7, which includes at least one mast ram member 94 slidably received within a ram receiving member 95 which are vertically oriented to cause the carriage assembly 13 to move vertically up and down the mast frame 21.

Preferably the mast ram apparatus 19 is a hydraulic mast ram apparatus. Preferably the hydraulic actuating apparatus 7 includes operating lever members 74, hydraulic valves 80 and hydraulic lines 58 and all operatively connected to the components of the assembly 1 to control movement of the ground stabilizing means 18, the carriage drive mechanism, the carriage assembly 13, in two modes, standard mode allowing user controlled rate of travel and detent which allows a controlled rate of movement independent of the operator accordingly wherein the lever members 74 are mounted on the mast frame.

Preferably the operating lever members 74 include two levers 111, 112 to operate the ground stabilizing means 18, one lever 113 to operate the carriage assembly 13 and two levers 114, 115 to calibrate controlled distal movement of the carriage assembly 13 and one lever 116 to control the forward and back adjustment of the mast assembly 58 with seating ram member 60 wherein;

levers 111 and 112 control separately or together, the ground stabilizing means 18,

Lever 113 is operatively connected to the carriage hydraulic motor 106 to provide rotational movement i.e. drilling of the ground penetrating member 15,

lever 114 is operatively connected to slidably move the carriage assembly 13 up and down the mast frame 21 in regard to speed control which allows for coarse control of the carriage assembly 13,

lever 115 is operatively connected to the carriage assembly 13 for controlled distance movement through a flow control valve or similar allows for controlled adjustment at a constant rate of travel normally for example at 1 meter per minute,

lever 116 is operatively connected to the mast adjustment ram which allows the mast position to be adjusted to a perpendicular position when pushing the rod 15 or any other attachment into the ground.

Preferably the apparatus includes a support apparatus which includes a vehicle mounting apparatus 49 which is removably and adjustably attached to a vehicle 122, wherein the vehicle mounting apparatus 49 includes at least one cantilevered elongate member 50 extending rearwardly of base support member 20 and including a plate member 51 which is vertically oriented and connectable to the vehicle 122.

Preferably the apparatus can be mounted on a vehicle as shown or a tracked unit, tractor, trailer or any other means of making the unit mobile for field use.

Preferably the base support frame 20 includes a mast supporting brace 45 which includes a post member 47 and angle member 48 wherein the post member 47 is connectable to the mast support on a front side of the base support frame 20 and being located parallel in orientation to the mast frame 21 and the angle member 48 extending from a top of the post member 47 outwardly rearwardly to an opposite side of the base support frame 20.

Preferably the carriage assembly 13 includes a load cell 137 and first end member fixing housing 130 and second end fixing housing or coupling 132 operatively connected together and to the power supply apparatus 9, to cause the ground penetrating member 15 to be moved up and down on mast frame 21 according to a defined downward load with the load able to be measured by the load cell 137.

Preferably the apparatus includes a data logger 77 which connects the output of the load cell 137 and a computer operating device 78 are operatively connected to the components of the apparatus to enable the computer operating device 78 to control and measure the results of the movement of the ground penetrating member 15.

Preferably the computer operating device 78 is a laptop or tablet to connect the components of the assembly either by cable or wirelessly.

Preferably the ground penetrating member 15 can include an elongate ground penetrating member, a cone penetrometer 140, a coring barrel 142, a split spoon sampler 144, a Dutch auger 146 or an auger 148 or any means of drilling or boring for the purposes of extracting sample for observation or creating a hole or determining bearing strength.

The various embodiments described above include a number of different features, and it will be apparent to one skilled in the art that they may be combined in combinations other than those specifically described, in order to achieve the object of the invention, and without departing from the spirit and scope of the present invention. All such modifications and variations as would be apparent to persons skilled in the art fall within the broad scope and ambit of the invention.

### BRIEF DESCRIPTION

The invention will now be described, by way of example only, by reference to the accompanying drawings:

FIG. 1 is a perspective front view of the invention in a transport mode or retracted mode with a carriage assembly at its highest position (ie probe up) and stabilizer means and stabilizer rams in a retracted position.

FIG. 2 is a perspective front view in an in use position with the carriage assembly (eg probe down) at its lowest position and stabilizer means and rams in an extended position.

FIG. 3 is a perspective view of the base frame support with mast supporting brace and vehicle mounting apparatus.

FIG. 4 is a perspective view of the mast frame.

FIG. 5 is a closer up front perspective view of the inside of the power supply apparatus.

FIG. 6 is a perspective front view of the apparatus of FIG. 1 but with the carriage assembly located at its highest position, stabilizer means or rams extended and a laptop to control and record test results with the levers optionally mounted on the actuating apparatus.

FIG. 7 is a perspective front view of the apparatus similar to FIG. 1 but with the carriage assembly at its highest point with the ground penetrating member not penetrating the ground, with stabilizing means extended and the power apparatus housing opened and the levers optionally mounted to the mast supporting brace assembly 45.

FIG. 8 is a perspective front view of the apparatus similar to FIG. 7 but with the carriage assembly at its lowest point with the stabilizer means extended and the ground penetrating member penetrating the ground and the levers optionally mounted to the actuating apparatus.

FIG. 9 is a perspective rear view of the apparatus of the invention similar to FIG. 7 in an in use configuration, with the carriage assembly at its lowest position with the ground penetrating member (eg probe) extending into the ground and stabilizer means (eg rams) in an extended position and laptop in position.

FIG. 10 is a front, view of the apparatus of the invention similar to FIG. 7 with the carriage assembly at its highest position with the ground penetrating member not extending into the ground and stabilizer means in a retracted position and laptop in position and showing the location of Section A-A as shown in FIG. 20.

FIG. 11 is a top plan view of the apparatus of FIGS. 2, 9, 10 with the laptop but with the stabilizing means extended or retracted.

FIG. 12 is a side view of the apparatus in a transport configuration with carriage assembly at its highest position with the ground penetrating member (eg probe) up and the stabilizing means (eg rams) retracted.

FIG. 13 is a side view of the apparatus with carriage assembly at its highest position and the stabilizing means extended.

FIG. 14 is a cross sectional side view of the apparatus with carriage assembly at its highest position and the stabilizing means extended.

FIG. 15 is a cross sectional side view of the apparatus in transport configuration with the carriage assembly at its highest position, ground penetrating member (eg probe) up and stabilizing means (eg rams) retracted.

FIG. 16 is a cross sectional side view of the apparatus in an in use configuration with the carriage assembly at its lowest position, ground penetrating member (eg probe) down and stabilizing means (eg rams) extended. With Load cell 137

FIG. 17 is a cross sectional side view of the apparatus in an is use configuration with the carriage assembly at its highest position, ground penetration member (eg probe) down and stabilizing means (eg rams) extended similar to FIG. 16 but with the location of the close up Detail A shown.

FIG. 18 is a close up side view of part of the apparatus with the carriage at the lower position, labelled Detail A from FIG. 17.

FIG. 19 is a first close up perspective view called Detail B.

With the Load cell 137 and end fixing housing

FIG. 20 is a cross sectional side view along Section A-A from FIG. 10, of the apparatus in an in use configuration with the carriage assembly at its lowest position, ground penetrating member (eg California Bearing Ratio—CBR) attached and stabilizing means (eg rams) downwardly extended similar to FIG. 16 but with the location of the close up view A shown.

FIG. 21 is a close up perspective view of part of the apparatus with the carriage assembly at the lowest position, labelled Detail A from FIG. 17.

FIG. 22 is a close up perspective view called Detail B.

With Load cell and CBR apparatus 135 for the ground penetrating member

FIG. 23 is a perspective view of the apparatus attached to a rear of a vehicle in a transport configuration with carriage assembly at its highest position, ground penetrating member (eg probe) up and stabilizer means (eg rams) retracted.

FIG. 24 is a perspective view of the apparatus attached to a rear of a vehicle in an in use configuration with carriage assembly at its lowest position, ground penetrating member (eg probe) down and stabilizer means (eg rams) downwardly extended. Laptop included

Without Laptop 78 and apparatus in transport configuration with ground penetrating member (eg probe) up and stabilizing means (eg rams) upwardly retracted

FIG. 25 is a side view of the apparatus on a vehicle with the stabilizer means retracted.

FIG. 26 is a front end view of the apparatus looking at the rear of the vehicle.

FIG. 27 is a top view of the apparatus and vehicle.

FIG. 28 is a rear view of the apparatus from the front of the vehicle.

With laptop 78 and apparatus in an in use configuration with the ground penetrating member (eg probe) down and stabilizing means (eg rams) downwardly extended

FIG. 29 is a side view of the apparatus on a vehicle with the stabilizer legs extended with the probe in a downward position

FIG. 30 is a front end view of the apparatus looking at the rear of the vehicle.

FIG. 31 is a top view of the apparatus and vehicle.

FIG. 32 is a rear view of the apparatus from the front of the vehicle.

Ground penetrating members—selected end members

FIG. 33 is a side view of a ground penetrating member being a cone penetrometer.

FIG. 34 is a side view of a ground penetrating member being a coring barrel.

FIG. 35 is a side view of a ground penetrating member being a split spoon sampler.

FIG. 36 is a side view of a ground penetrating member being a Dutch auger.

FIG. 37 is a side view of a ground penetrating member being a continuous flight auger.

### DESCRIPTION OF DRAWINGS

The following description will describe the invention in relation to preferred embodiments of the invention, namely a penetration testing apparatus 1. The invention is in no way limited to these preferred embodiments as they are purely to exemplify the invention only and that possible variations and modifications would be readily apparent without departing from the scope of the invention.

FIGS. 1-37 show penetration testing apparatus 1 which includes the following main components including a frame support 5, actuating apparatus 7, power supply apparatus 9, movable carriage assembly 13, ground penetrating member 15, carriage drive mechanism 17 and a mast ram apparatus 19, and ground stabilizer means 18 all being operatively connected by appropriate power connection means to mechanically slidably operate the carriage assembly 13 and ground penetrating member 15 to contact or penetrate the ground.

In this example, the carriage drive mechanism 17 can include a flexible drive member such as a strap member or chain link member. The power connection means can include any means suitable to enable the power to power the components of the apparatus such as for example electric cabling or hydraulic or pneumatic lines.

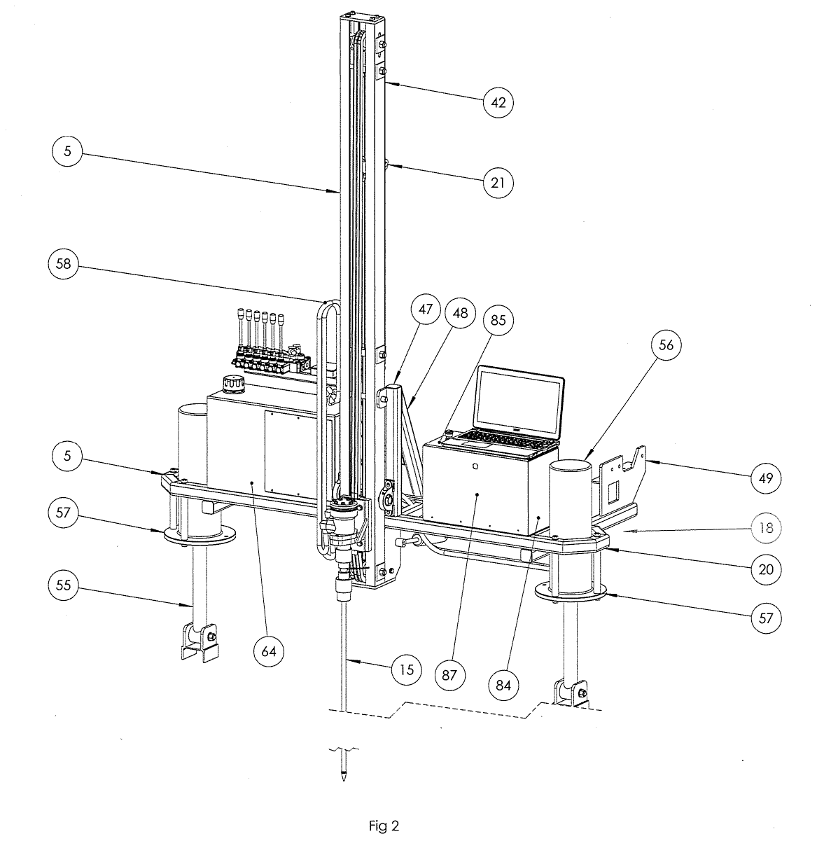

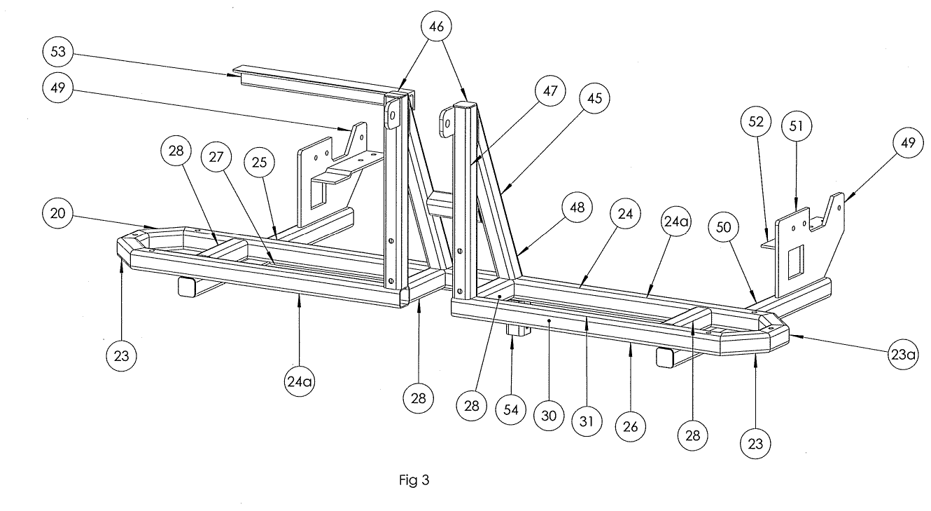

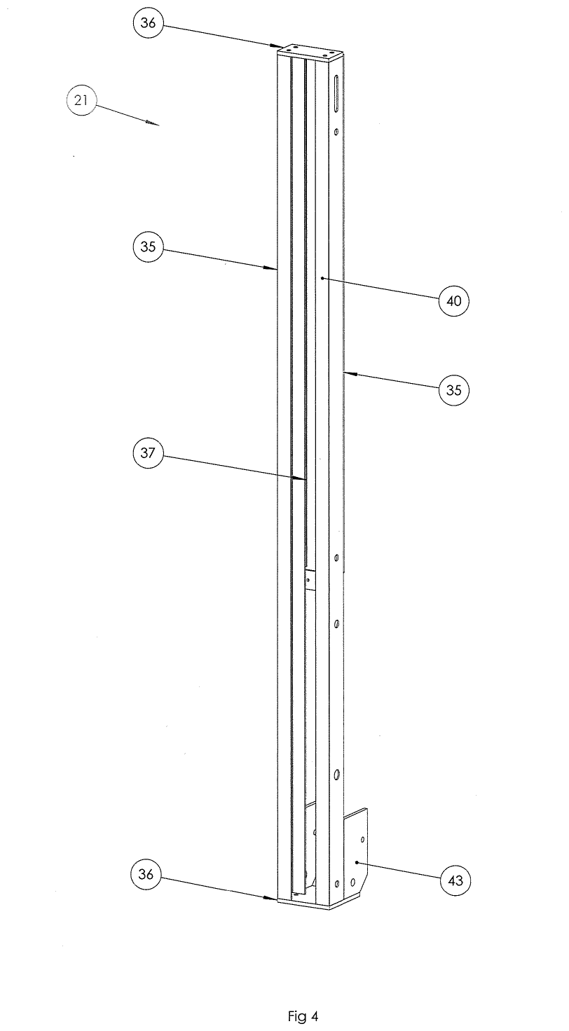

As shown in FIGS. 2 and 3 frame support 5 comprises an elongate base support frame 20 and mast frame 21 whereby the mast frame 21 extends in use, substantially vertically from and overlaps with the base support frame 20 which is horizontally oriented.

Base support frame 20 of FIG. 3 includes an elongate rectangular shape of channel cross section having rounded ends 23, sides 24, upper surface 25, lower surface 26 which includes a perimeter frame comprising end members 23a and side members 24a having an inner space 27 there between and cross frame members 28 extending within the inner space 27 from side to side. As shown in the drawings the channel cross section includes side walls 30 and base walls 31 and inner space 32 there between whereby the side walls 30 are oriented to lie in a vertical plane and the base walls 31 in a horizontal plane whereby the channel is oriented with the base wall 31 on top as shown in the drawings. Stabilizer plates and beams 33 can be provided underneath the base support frame 20 i.e. lower surface 26, to span from side to side.

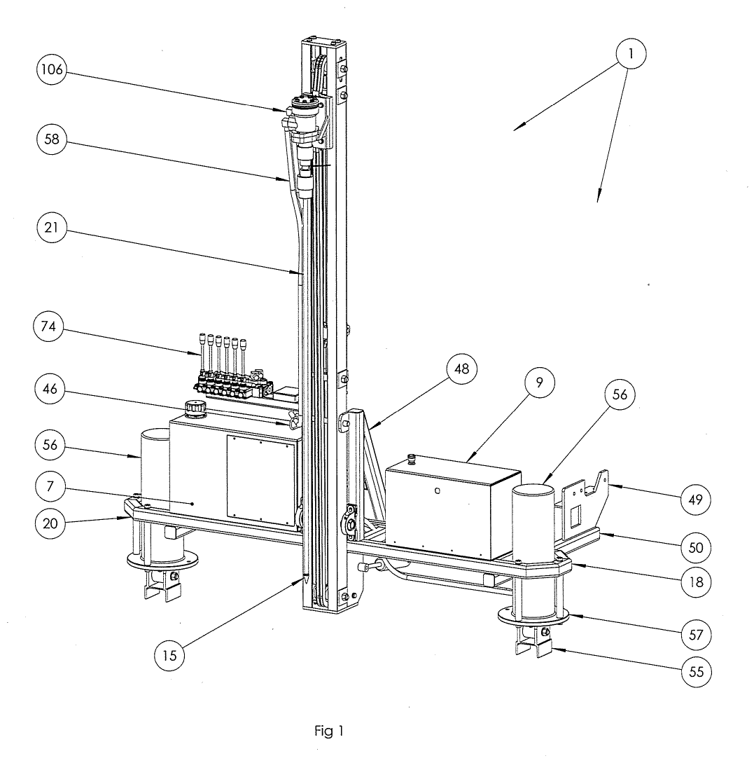

The mast frame 21 of FIGS. 1,2,4, 6-10, and 12-32 includes an elongate rectangular shape, having an upper end lower end and sides which includes a perimeter frame comprising elongate side members 35, elongate end members 36 forming an inner space 37 there between the side members 35 of the mast frame 21 comprise a channel cross section having side walls 40 and base 41 whereby in use a shown in the drawings (see FIG. 1) the side walls 40 file oriented vertically facing the front and rear of the apparatus and the base 41 is oriented vertically on the sides of the mast frame 21 whereby the both side members 35 face other with the inner space facing each other. The elongate end members 36 comprise plate members and there are at least one cross member spinning from side to side but comprising rod members 42 rotatably mounted to the base 41 of the side members 35.

As shown mast frame 21 can be removably connected and locked to the base frame 20 using any suitable means such as for example welding or at least one lock pin or bolt 43. The rod members 42 also include a wheel cog member 44 having teeth to be operatively connected to spaces between the chain links of the chain link member 17.

The base support frame 20 also includes mast supporting brace assembly 45 as shown in FIG. 3 which comprises a triangular shaped frame with a vertical support post member 47 and angle support member 48 whereby the vertical support member 47 is fixed to a lower end of the elongate rectangular frame shape of the mast frame 21 with the angle support member 48 being fixed at an upper end of vertical support member 47 on one side 24 of the base support frame 20 and extending at an angle to an opposite side 24 the base support frame 20.

As shown in the figures there can be at least one mast support brace 45 located and connected on each side of the outside of the lower end of the side members 35 of the mast frame 21. As shown in the figures, a lower portion of the elongate rectangular mast frame 24 extends below base support frame 20. Mast supporting fixing brackets 46 are provided as cleats or small plates which are vertically oriented as flaps extending forward of the base support frame 20. Also as shown in the figures, the mast frame 21 includes a bracket support member 43 comprising two parallel plate member extending from one side of a lowest portion of the side members 35 to be connected to a portion of the base support frame 20.

Also shown in FIG. 3 the base support frame 20 includes a vehicle mounting apparatus 49 comprising at least one cantilevered elongate member 50 being horizontally oriented and extending rearwardly of the base support frame 20 being fixed or connected to underneath both side members 24a of the base support frame 20 to have an cantilevered horizontal portion with an upwardly and vertically oriented shaped plate member 51 for connection to a vehicle 122. Plate member 51 can also have horizontal oriented shelf member 52 facing inwardly towards the mast frame 21 to assist in fixing to the chassis of a vehicle 122. As shown in FIG. 3 mast support frame 21 can include a platform 53.

Chain link member 17 comprises an elongate member operatively supported within the mast frame 21 and connected to the actuating apparatus 7 and to carriage assembly 13 and ratatably supported by spaced rotatably mounted rod members 42 spanning between the side members 35 of the mast frame 21 over the complete length of the mast frame 21. As shown in the figures, the chain link member 17 comprises a plurality of movably linked spaced chain links.

Ground stabilizing means 18 includes stabilizing leg assemblies which each assembly comprise a ram apparatus or ram comprising a leg ram member 55 slidably supported within a tubular ram receiving member 56. The tubular ram receiving member 56 is upwardly and vertically supported on top of the base support frame 20 when retracted and leg ram member 55 (being co-linear with the tubular ram receiving member 56) in use is slidably supported (see cage type frame 57 in FIGS. 1, 2 which each includes side spacing rods and an end ring plate member) underneath base support frame 20 to extend downwardly to the ground to provide support or upwardly above the frame 20 when retracted. There is at least one ground stabilizing means 18 located at each of the base support frame 20, the purpose of which is to allow the vehicle to be raised which in turn allows its mass to be utilised to push ground penetrating member 15.

A seating ram member 60 is adjustable and connected underneath to cantilevered support member 50 of the support frame 20, to ensure that the mast frame 21 when set up to conduct a test is perpendicular to the ground subject to test or at an angle as required by the operator.

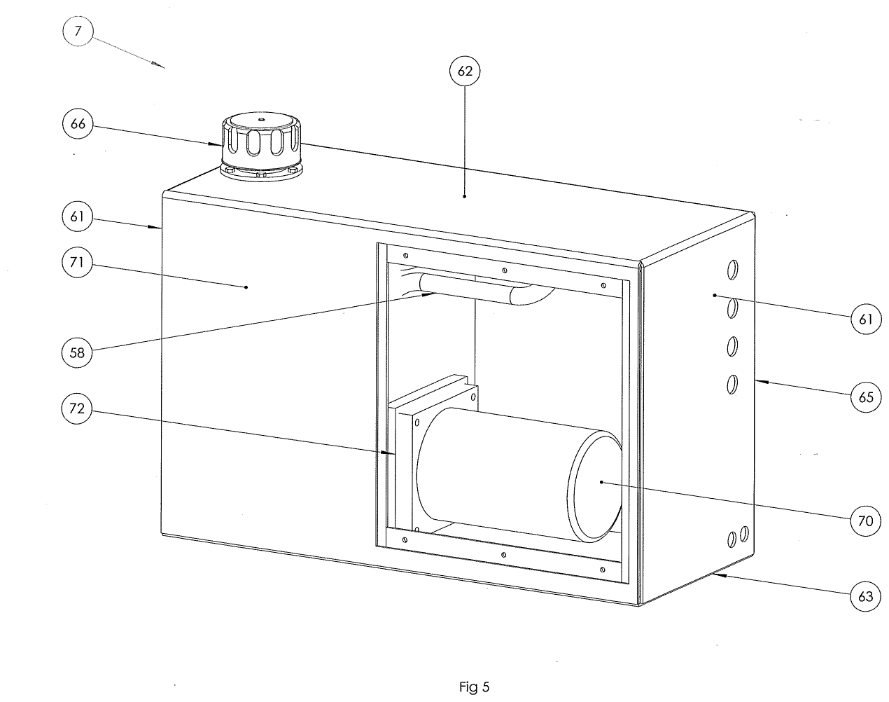

As shown in FIG. 5 the actuating apparatus 7 which is adapted to receive electrical power from the power supply apparatus 9, to power all the components of the apparatus. In this example if using hydraulics, the actuating apparatus can be a hydraulic actuating apparatus which is adapted to receive electrical power from a battery 82 to then convert to provide hydraulic power through appropriate connecting means in the form of hydraulic lines 58 to drive all the hydraulic rams (as part of the ground stabilizing means 18, the mast ram apparatus 19 and ground penetrating members 15), of the present invention, which includes an actuating apparatus housing comprising a rectangle box with side walls 61, roof 62, base 63, front wall 64, rear wall 65 and an enclosed space and filling aperture and cap 66 and at least one outlet drain.

The enclosed space of the actuating apparatus housing includes the following components operatively supported and connected together therein which includes an electric motor 70, a reservoir or tank 71 for hydraulic fluid, a hydraulic pump 72, operating lever members 74 and hydraulic lines 58 (eg tubing with hydraulic fluid therein). The motor 70 and pump 72 can be called a “power pack”. The actuating apparatus housing is located between the ram receiving member 56 of the ground stabilizing means 18 and one side of a side of the mast frame 21 with the housing base 63 being connected to upper surface 25 of the base support frame 20.

As shown in FIG. 3 the operating (eg hydraulic) lever members 74 are mounted on platform 53 to allow easy access by the operator. While the hydraulic member mounting platform is shown to be rigidly mounted, this hydraulic member mounting platform 53 may pivot on one corner to allow the operator to change their position of operation.

The actuating apparatus 7 is engaged to provide power to cause actuating (eg hydraulic or other) flow to move all the hydraulic rams (as part of the ground stabilizing means, the mast ram apparatus and ground penetrating members), and provide measurement control and a monitoring control bank like for example a computer including a computer operating device 78 eg laptop or tablet etc by wire or wirelessly. The hydraulic power pack (motor and pump) self circulates with operating lever members 74 which controls the mode the particular component is required to carry out which includes up and down modes for the carriage assembly 13, ground stabilizing means 18 and mast ram apparatus 19 directions. A data logger 77 is connected to the computer device 78.

Additionally the hydraulic actuating apparatus 7 also has hydraulic valves 80 operatively connected to each lever handle and at least one pressure transducer 81 is operatively connected to at least one of the hydraulic valves 80.

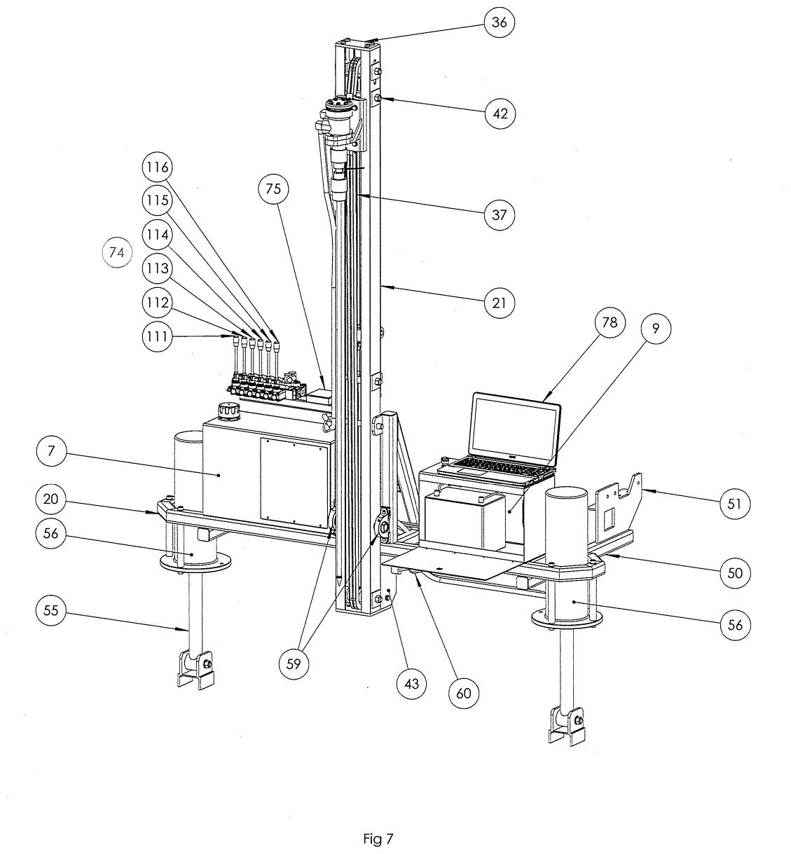

As shown in FIG. 7 the power supply apparatus 9 includes a power housing which encloses and supports a portable power means in this example in the form of a battery 82. The power housing comprises a rectangle box with side walls 84, roof 85, base 86, openable front wall 87, rear wall 88 and an enclosed space. Additional batteries may be stored on the vehicle to which the apparatus is attached.

An emergency Stop device or E stop device 93 is also operatively mounted to the battery 82 as a safety precaution to provide safety cut out when as required.

The power supply apparatus 9 is located on an opposite side of the mast frame 21 to that of the actuating apparatus 7, to be located between the mast frame 21 and ground stabilizing means 18 with its base 86 located on top of upper surface 25 of the base support frame 20.

The power supply apparatus 9 is operatively connected to the actuating apparatus 7 by supplying electric power to the electric motor 70 which in turn provides and converts power to the hydraulic pump 72 via electrical connecting means such as electric lines 75. Additionally power supply apparatus 9 includes the on/off switch charge controller 92 and an E-stop device 93 which are mounted inside the power housing.

The lever members 74 include several levers (in this example there are six levers 111, 112, 113, 114, 115 and 116) which are operatively connected via the hydraulic connecting means (e g lines) 58 from the hydraulic pump 72 to various components of the penetration testing apparatus 1. The operating lever members 74 include two levers 111, 112 to operate the ground stabilizing means 18, one lever 113 to operate the carriage assembly 13 and two levers 114, 115 to calibrate controlled distal movement of the carriage assembly 13 and one lever 116 to control the forward and back adjustment of the mast assembly 58 with seating ram member 60.

The mast ram apparatus 19 includes at least one mast ram member 94 and at least one tubular ram receiving member 95 which is operatively connected to a non-end portion of the mast frame 21 and to the carriage drive mechanism 17 of the mast frame 21 to cause mast ram member 94 slidably inside ram receiving member 95 to move from a retracted position to a non-retracted position and vice versa to move the carriage assembly 13 up and down the mast frame 21 as required. In this example the mast ram apparatus 19 can be a hydraulically operated mast ram.

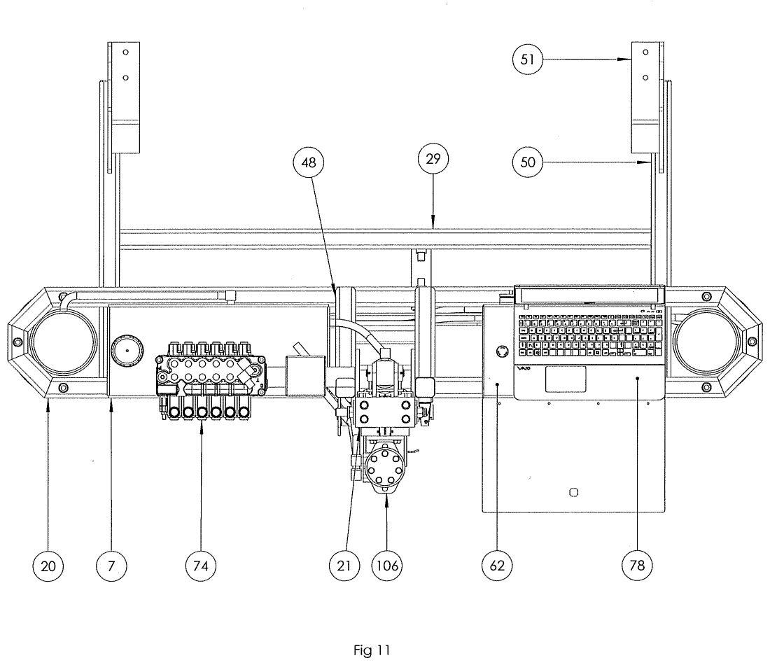

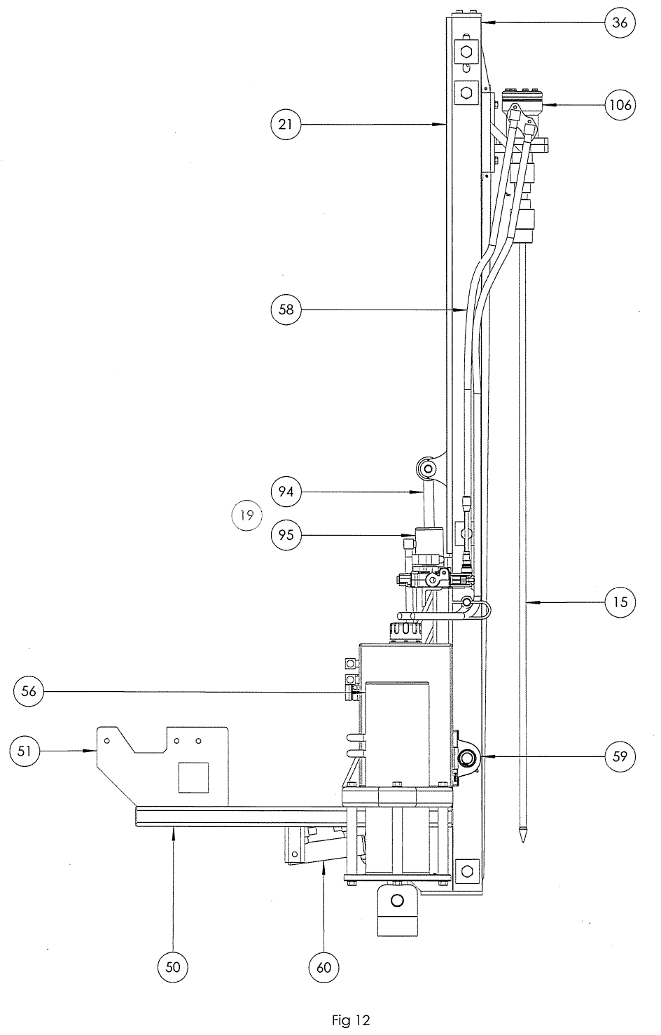

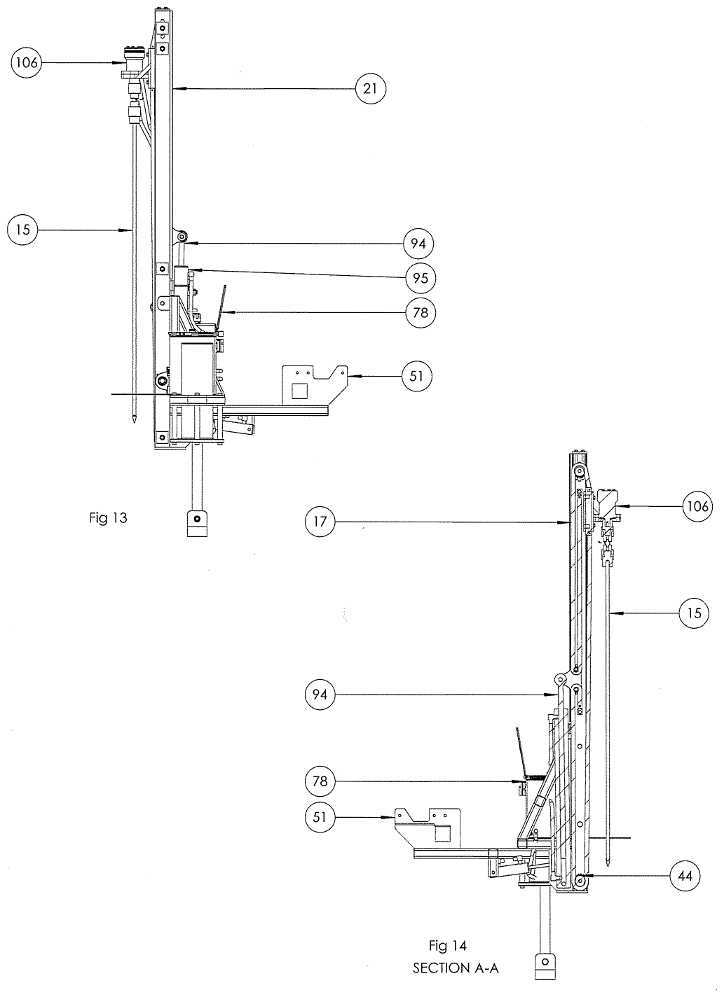

FIGS. 12-15, show the retracted position with the mast ram member 94 not extended, whereby the carriage assembly 13 is located at a specific position or height at the top of the mast frame 21.

FIG. 9, shows the mast ram member 94 upwardly extended from ram receiving member 95, to cause the carriage assembly 13 via the chain link member 17 to drop and cause the ground penetrating member 15 to hit or penetrate the ground or soil.

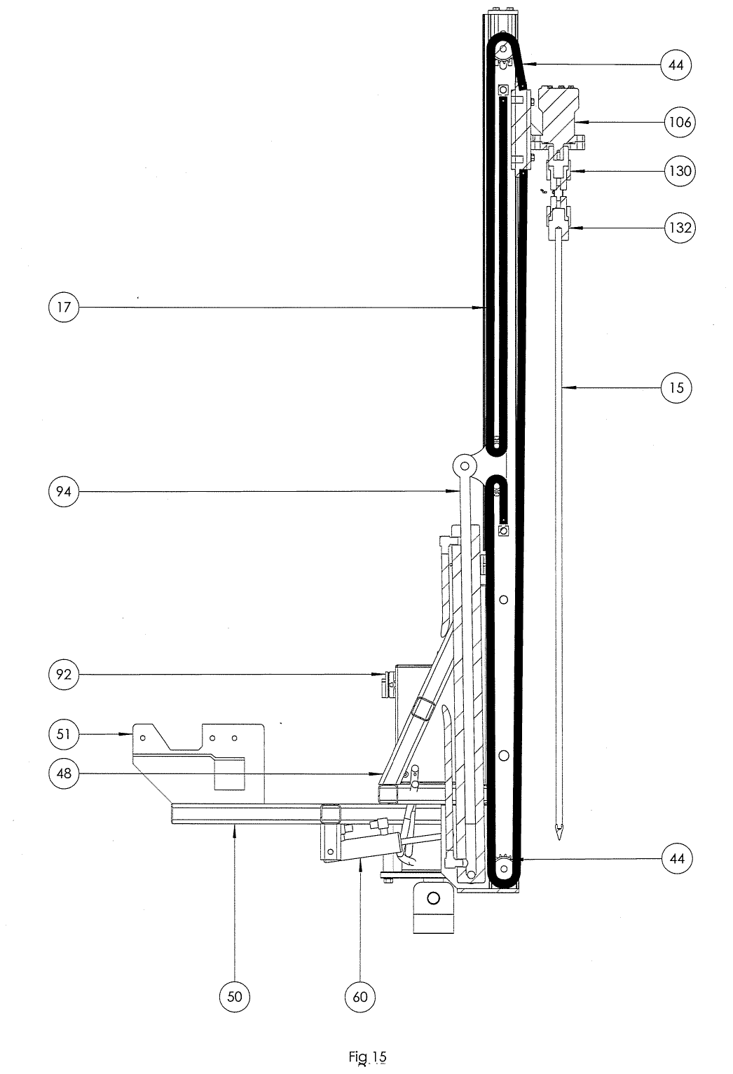

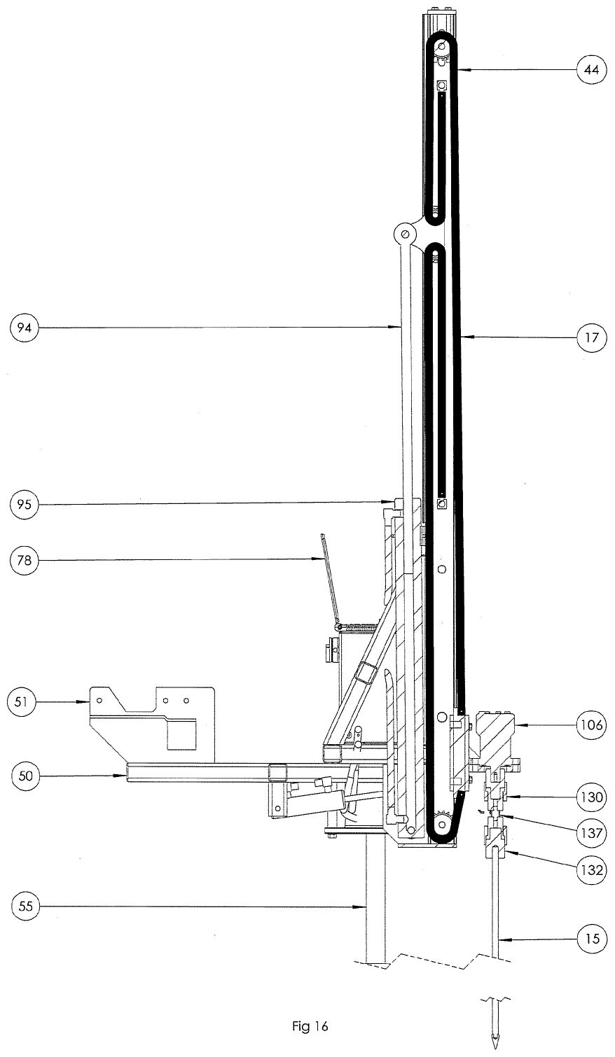

Carriage assembly 13 is more clearly seen in FIGS. 15-23 includes a front plate member 100 separated and connected from a rear plate member 102 by a spacer member 104, together forming side channels for sliding receipt by one of side walls (i.e. a front) of each of the side members 35 of the mast frame 21. Front plate member 100 is operatively connected to the chain link member 17. Carriage assembly 13 also includes a carriage hydraulic motor 106 operatively connected to the levers 74 via hydraulic lines 58 to rotate the ground penetrating member 15. The front plate member 100 is connected and operatively supports the carriage hydraulic motor 106.

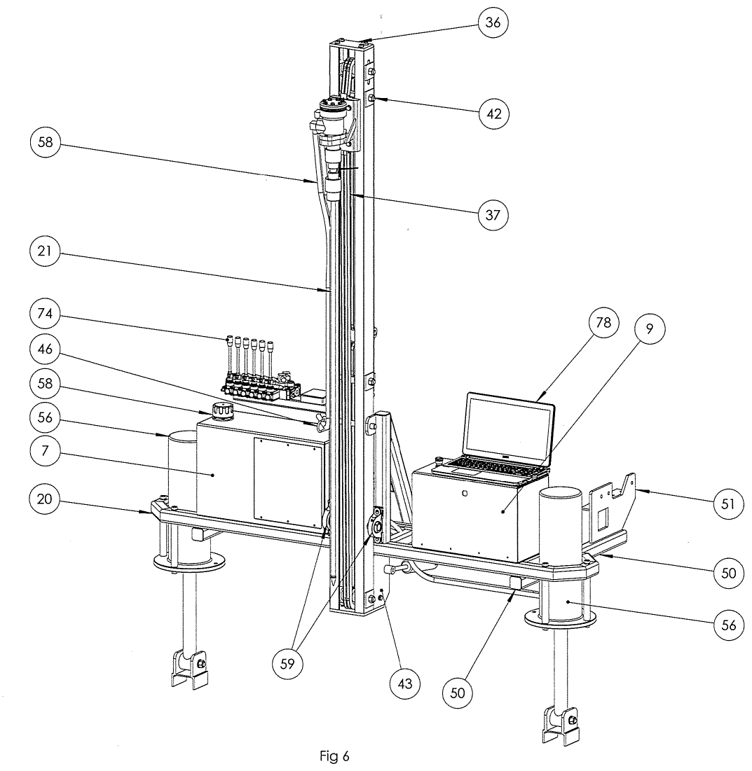

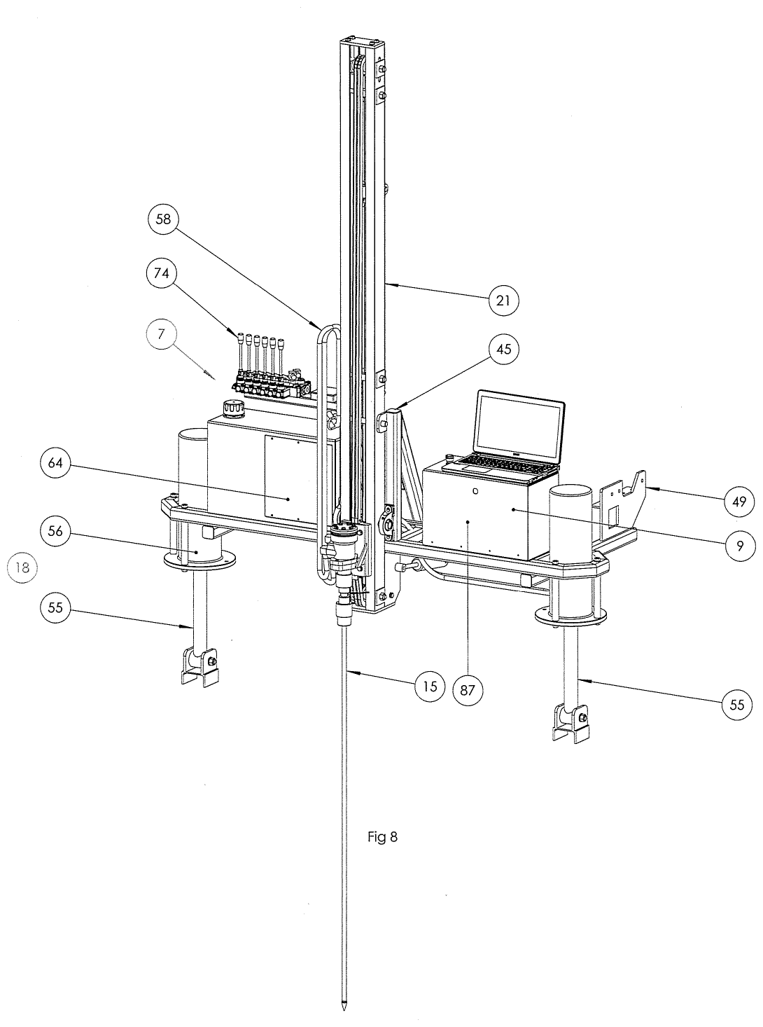

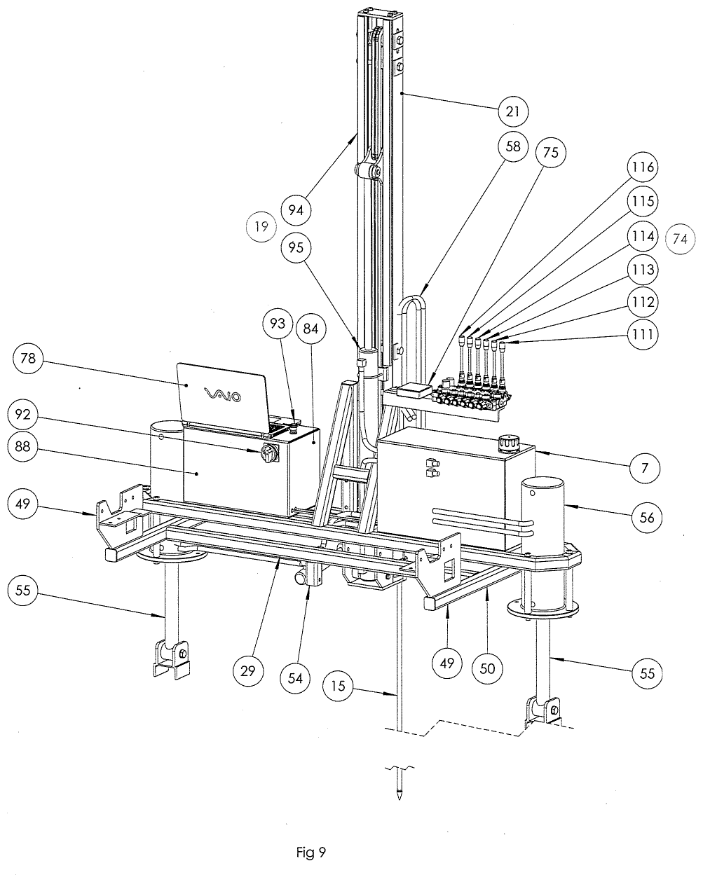

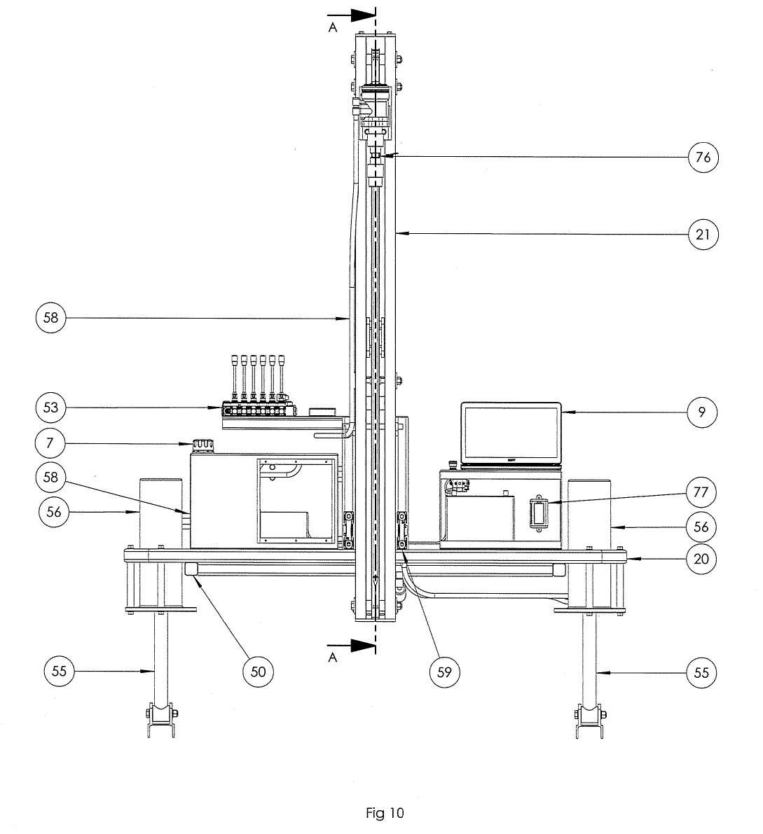

From left to right as seen in FIGS. 6 and 8 there are five levers 74 whereas in FIGS. 1, 2, 7, 9-11, 23, 24, there are six levers 74.

Levers 111 and 112 control separately or together, the ground stabilizing means 18.

Lever 113 is operatively connected to the carriage hydraulic motor 106 to provide rotational movement i.e. drilling of the ground penetrating member 15.

Lever 114 is operatively connected to slidably move the carriage assembly 13 up and down the mast frame 21 in regard to speed control which allows for coarse control of the carriage assembly 13.

Lever 115 is operatively connected to the carriage assembly 13 for controlled distance movement through a flow control valve or similar allows for controlled adjustment at a constant rate of travel normally for example at 1 meter per minute

Lever 116. Is operatively connected to the mast adjustment ram. This allows the mast position to be adjusted to a perpendicular position when pushing the rod 15 or any other attachment into the ground

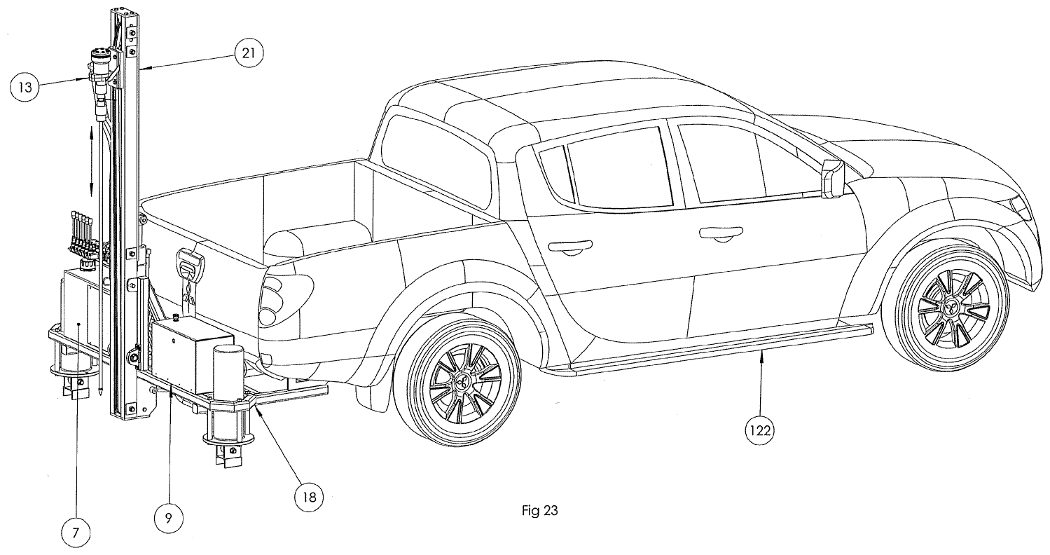

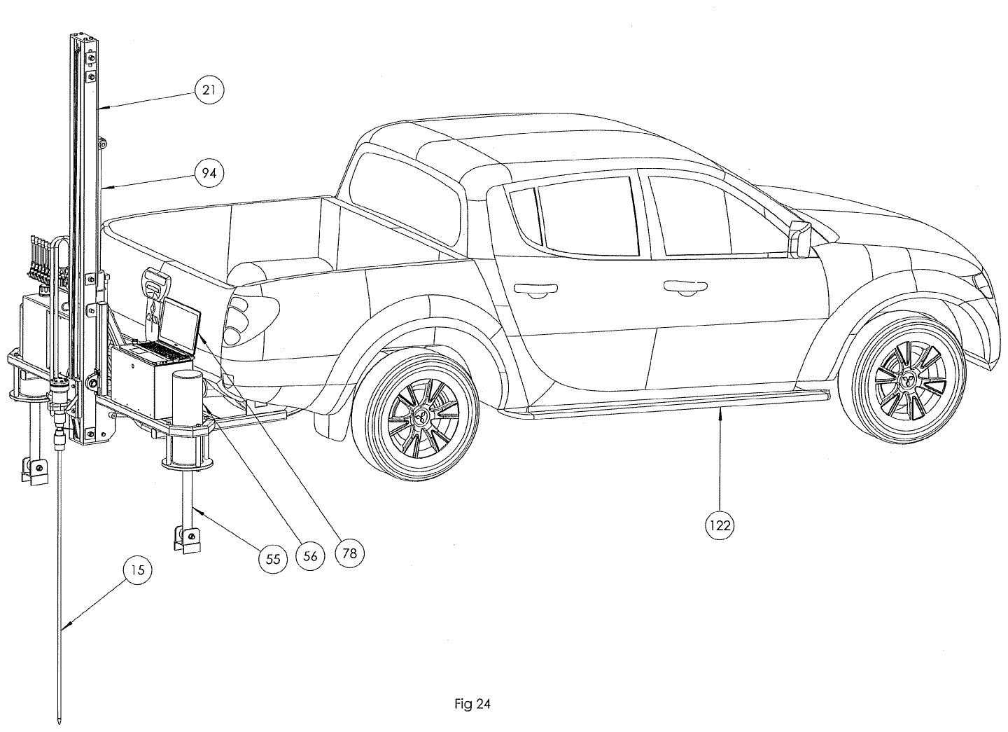

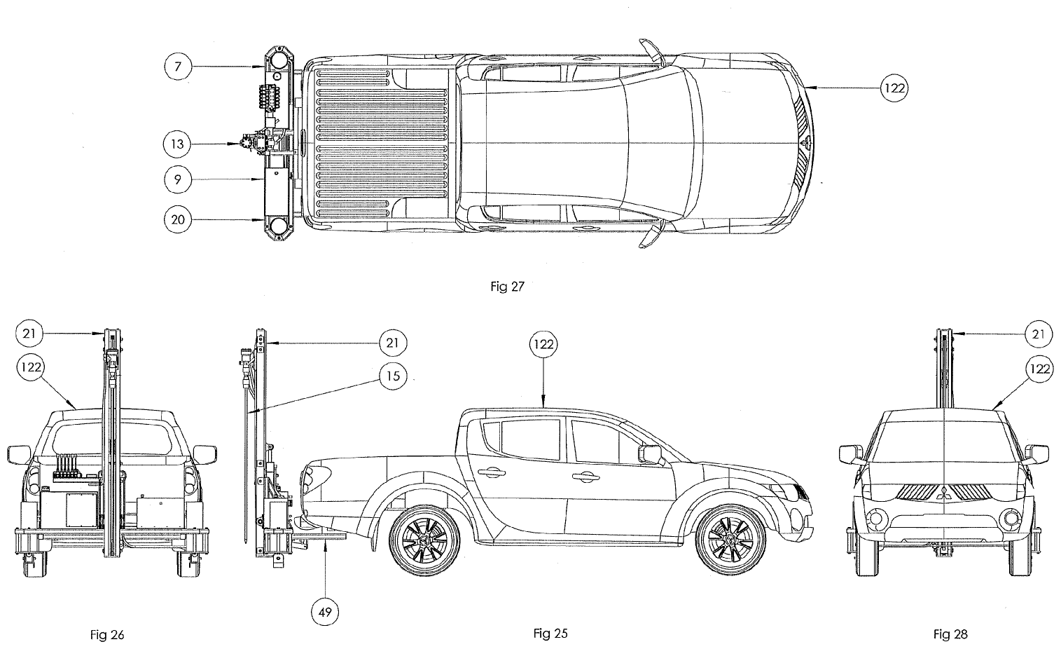

As shown in FIGS. 23-32 the penetration testing apparatus 1 can be attached to a rear of a vehicle 122. During movement and positioning of the penetration testing apparatus 1 and vehicle 122, the carriage assembly 13 and ground stabilizing means 18 are both positioned to be in a retracted position as shown in FIGS. 23, 25-29 whereby all the wheels of the vehicle touch the ground.

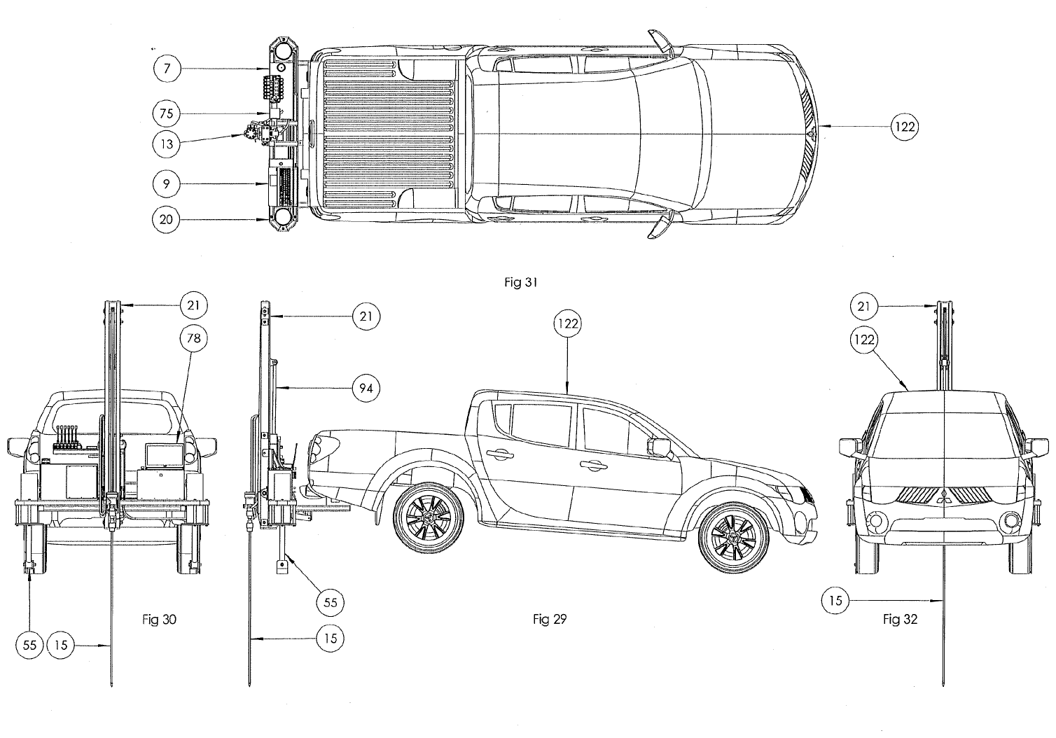

However as seen in FIGS. 29-32 when the apparatus and vehicle 122 are positioned to be ready for testing, the ram members 55 of both ground stabilizing means 18 are caused to be downwardly extended to contact the ground which causes the rear wheels of the vehicle 122 to be lifted off the ground. After that the carriage assembly 13 is moved to a pre-determined height, downwardly during the actual testing process as a constant rate penetrometer test.

The penetration testing apparatus of the present invention can be used to carry out at least one of the following or any other selected tests:
1. Constant rate penetration tests
2. In-situ California Bearing Ratio testing
3. Core cutting tests
4. Auger boreholes tests
5. Cone Penetration testing

These tests utilize different ground penetrating members 15 ie different end members or probes which can be interchanged or combined as required.

Operational Steps

Penetration testing apparatus 1 is removably attached to the rear of a vehicle 122 whereby the apparatus 1 is bolted to a chassis in a similar position to a standard tow-bar.

Power for the penetration testing apparatus 1 is activated by the actuating apparatus 7 run from battery 82. Battery 82 can be recharged by a vehicle alternator so a cable can be installed to electrically connect them if required.

Actuating apparatus 7 includes operating lever members 74, hydraulic valves 80 and hydraulic lines 58 which are all operatively connected to the components of the assembly 1 to control movement of the ground stabilizing means 18, the carriage drive mechanism, the carriage assembly 13, in two modes, standard mode allowing user controlled rate of travel and detent which allows a controlled rate of movement independent of the operator accordingly.

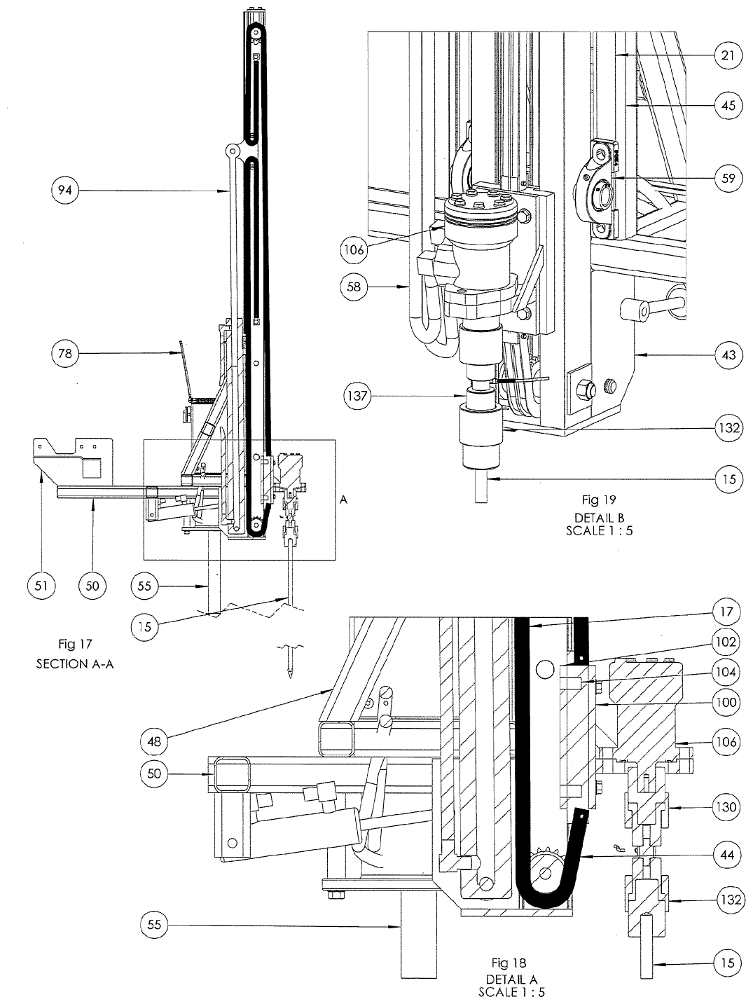

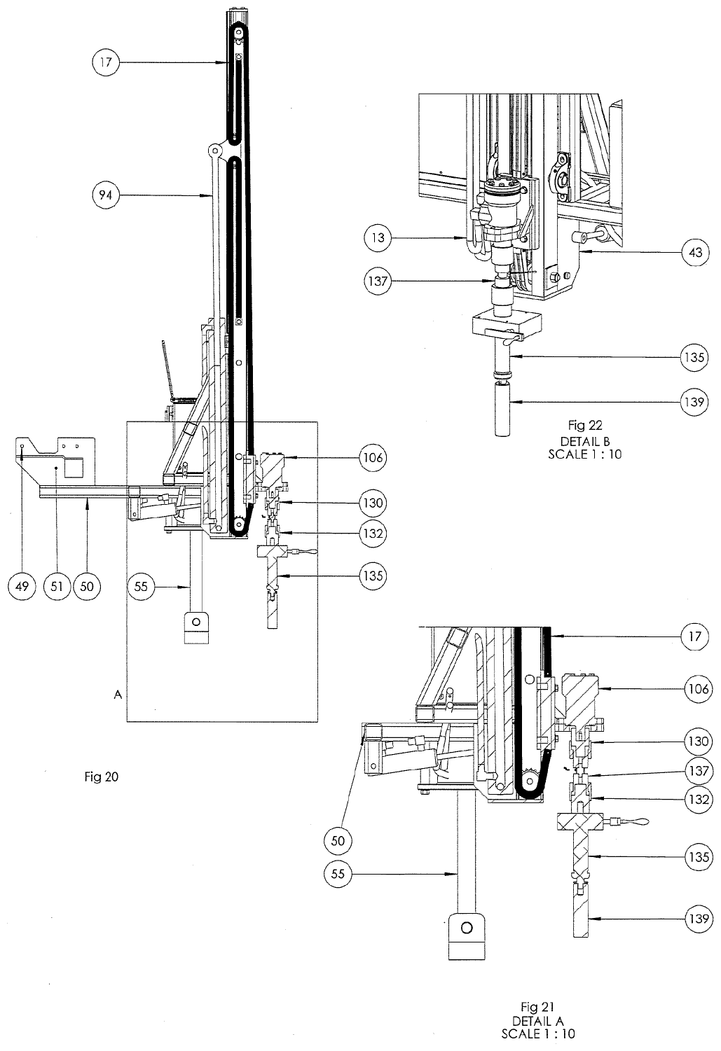

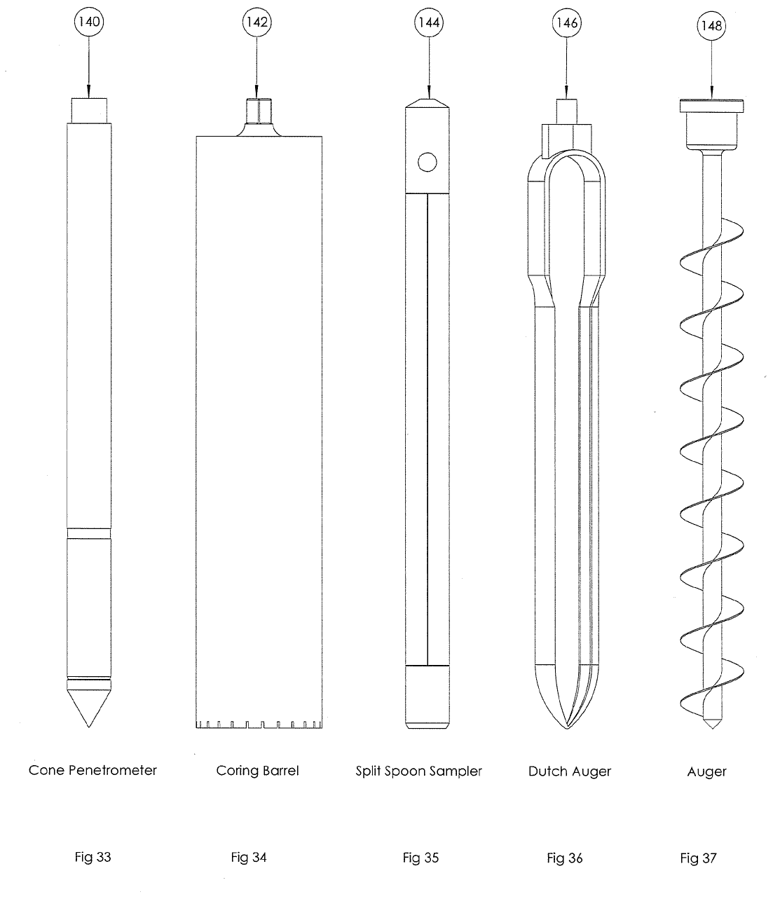

As shown in FIGS. 1, 2, 6-20 and 24-32 at the carriage assembly 13, which is operatively connected to the carriage hydraulic motor 106, there is shown a first end member fixing housing 130 which allows for interchanging of the ground penetrating member 15 with other ground penetrating members as seen in FIGS. 33-37. As seen in FIGS. 20-22 there is shown a second end member fixing housing or coupling 132 which includes a manually operated CBR apparatus 135 and load cell 137 which are both operatively connected and powered electrically directly from the battery 82.

The data logger 77 which connects the output of the load cell 137 and the computer device 78 are operatively connected to the components of the apparatus to enable the computer device 78 to control and measure the results of the movement of the ground penetrating member 15. The load cell 137 is connected between the first end member fixing housing 130 and second end member fixing housing 132.

As shown in FIGS. 33-37 the end members or probes of a ground penetrating member 15 can be interchanged with selected end members including:
Cone penetrometer 140
Coring barrel 142
Split spoon sampler 144
Dutch auger 146
Auger 148
CBR apparatus with end member 139—see FIGS. 20-22

Constant Rate Penetrometer Test
1. The mechanism of the penetration testing apparatus 1 first requires calibration to correlate the force being exerted by the ground penetrating member 15 (eg a probe or rod) to a reading on the load cell 137 of the actuating apparatus 7. Once calibrated, the apparatus 1 can be used for all soil types. As soil resistance increases, the reading from the load cell 137 increases.
2. Operate the levers 111 and 112 whereby the leg ram members 55 are extended downwards. At this stage leg ram members 55 can allow for the levelling of the rear of the vehicle 122 as required.
3. If required lever 116 can be used to adjust the position of the mast frame 21 in a forwards and backwards motion. This allows the rod 15 to be perpendicular to the ground surface.
4. Lever 114 is then used to position the carriage assembly 13 so the rod cone tip 85 comes into contact with the ground. The movement of the mast ram member 94 by this lever 114 allows for the rapid movement to quickly find the required position. The arrangement of the carriage drive mechanism increases the movement of the carriage assembly 13 by a magnitude of 2 or greater than the movement of the mast ram member 94.
5. Once in position lever 115 is then engaged. In the hydraulic circuit there is a flow control valve (needle valve or similar) to control the speed of the penetration of the rod. Lever 115 has detent capability to allow the motion to be engaged at a constant rate of penetration, and maintained without operator interaction so that they are free to interact with monitoring and recording the load cell output 137. Measurements should be taken at every 50 to 100mm of penetration or at specific time intervals as required to allow a profile of bearing strength compared with depth to be plotted. Where fitted a linear transducer can be used to measure the distance of the probe has travelled.
6. Once the testing to the required depth of the ground penetrating member 15 in the ground is complete, lever 114 can be used to reverse the direction of the carriage to remove the probe 15 from the ground.
7. Lever 114 is then engaged to rapidly upwardly remove the ground penetrating member 15 from the ground in an upward motion.
8. On completion of the testing, levers 111 and 112 are then engaged to retract the leg ram members 55.

Auger Boreholes (see FIGS. 36, 37) and Core Cutting (see FIG. 34)
1. Operate levers 111 and 112 whereby the leg ram members 55 are extended downwards. At this stage, leg ram members 55 can allow for the levelling of the rear of the vehicle 122 as required. Lever 116 can be used to adjust the position of the mast.
2. Auger length and head to be connected to the carriage assembly 13.
3. Lever 114 is then engaged to move the auger head or coring barrel to be moved into contact with the ground or surface.
4. Once in contact with the ground, lever 113 is engaged to allow rotation of the auger and lever 114 is engaged to allow downward motion.
5. To extract the auger or coring barrel, lever 114 is used for upward motion.

Possible examples of attachments for ground penetrating members 15 with different end members:
Cone Penetrometer 140 as shown in FIG. 33
Coring barrel 142 as shown in FIG. 34
Split spoon sampler 144 as shown in FIG. 35
Dutch auger 146 as shown in FIG. 36
Screw Auger 148 as shown in FIG. 37

In-situ California Bearing Ratio (CBR) Testing using a CBR test rig
1. Operate Levers 111 and 112 whereby the leg ram members 55 are extended downwards. At this stage leg rem members 55 can allow for the levelling of the rear of the vehicle 122 as required. Seating ram member 60 can be used to adjust the position of the mast to allow the CBR plunger 139 to be seated perpendicular to the test location.
2. If required a coring barrel 142 or similar can be attached to the carriage assembly 13 to allow the boring of a hole to test the soil at depth. Once the coring barrel 142 or similar is attached, lever 114 is used to move the coring barrel 142 into contact with the ground. Lever 113 will allow rotational movement to cut the hole. Lever 114 can be used for downward movement.
3. If required to cut a hole to test below ground level, once the hole has been cut to the correct depth, lever 113 is engaged to provide an upward motion for the carriage assembly 13.
4. The CBR test rig includes manually operated CBR apparatus 135 and CBR plunger 139, which is then moved into position and the underside of the CBR plunger 139 is moved to make contact with the soil or ground. Manually operated CBR apparatus 135 has a handle which is wound to control the rate of travel of the CBR plunger 139. Accepted rate of movement for the test can be 1 mm per minute to a total depth of 7.5 mm. The load cell 137 takes pressure measurements which are recorded by the laptop 78 through the data logger 77 for later download and data analysis.
5. On completion of the CBR test, the CBR rig is to be removed by raising the carriage assembly 13. The CBR rig is attached to the load cell 137 and the carriage assembly 13 by fixed housing 130 and coupling 132. The coupling 132 is unscrewed to separate the two (CBR rig and carriage assembly 13). The ground penetrating member 15 including any selected end member (eg 140, 142,144, 146 and 148) can then be re-attached or connected as required.

Optional Advantages

The present invention may have at least one of the following optional advantages.
a) Quick operation
b) Easy to transport
c) Accurate results
d) Consistent results
e) Automated operation
f) Reduced number of staff needed
g) One person operation is possible
h) Mechanical operation
i) Minimal manual operation required
j) Can be wireless to record test results
k) Can be mains or portable power
l) Reduced operating costs
m) Can operate in all weathers
n) Can be used for different tests including Constant Rate Penetrometer resting, auger boreholes & core cutting or sampling, split barrel sampling and California Bearing Ratio testing.

Variations

Throughout the description of this specification, the word “comprise” and variations of that word such as “comprising” and “comprises”, are not intended to exclude other additives, components, integers or steps. Hydraulic actuating means is disclosed in this specification as one example of a suitable operating systems able to operate and/or move all or some of the components of the apparatus 1 but equally other activating means such as electrical or pneumatic are also possible either in place of or in combination with.

It will of course be realised that while the foregoing has been given by way of illustrative example of this invention, all such and other modifications and variations thereto as would be apparent to persons skilled in the art are deemed to fall within the broad scope and ambit of this invention as is hereinbefore described.

The shape, length, height, width, cross sectional shape, number of cross members of the base support frame 20, mast frame 21 and ground supporting means 18 can be varied to suit requirements. Similarly for the support frame 45 this can also be varied without departing from the scope of the invention which can be made larger than that shown or be formed from a different elongate member cross section.

The apparatus can be mounted or removably mounted on a vehicle as shown or a tracked unit, tractor, trailer or any other means of making the unit mobile for field use. The ground penetrating means 15 can include any means of drilling or boring for the purposes of extracting sample for observation or creating a hole or determining bearing strength. The apparatus shows that a hydraulic power pack (combination of electric motor 70 and pump 72) and/or battery power unit 82 are located on the base support frame 20, and also in another option these maybe mounted on a transport vehicle or replaced by a power take off unit if required.

The flexible drive member 17 can include any means that is both flexible and able to be driven such as for example a chain link member, notched belt member, cable or strap. The number of levers 74 can be varied to suit requirements like for example there are 5 levers shown in FIGS. 6 and 8 whereas the other figures show 7 levers.

It will also be understood that where a product, method or process as herein described or claimed and that is sold incomplete, as individual components, or as a “kit of Parts”, that such exploitation will fall within the ambit of the invention.

These and other features and characteristics of the present invention, as well as the method of operation and functions of the related elements of structures and the combination of parts and economics of manufacture, will become more apparent upon consideration of the following description with reference to the accompanying drawings, all of which form part of this specification, wherein like reference numerals designate corresponding parts in the various figures.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

For purposes of the description hereinafter, the terms “upper”, “lower”, “right”, “left”, “vertical”, “horizontal”, “top”, “bottom”, “lateral”, “longitudinal”, “side”, “front”, “rear” and derivatives thereof shall relate to the invention as it is oriented in the drawing figures. However it is to be understood that the invention may assume various alternative variations, except where expressly specified to the contrary. It is also to be understood that the specific devices illustrated in the attached drawings, and described in the following specification are simply exemplary embodiments of the invention. Hence specific dimensions and other physical characteristics related to the embodiments disclosed herein are not to be considered as limiting. In this example “front” is meant to refer to a user facing a rear of a vehicle which serves to define a “rear” but this is only a relative orientation with other definitions being equally possible.

### SCHEDULE OF COMPONENTS

Penetration testing apparatus 1
Frame Support 5
Actuating apparatus 7
Power supply apparatus 9
Carriage assembly 13
Ground penetrating member 15
Carriage Drive mechanism—chain link member 17
Ground stabilizing means 18
Mast ram apparatus 19
Base support frame 20
Mast frame 21
Base support frame 20
Rounded ends 23
End members 23a
Sides 24
Side members 24a
Upper surface 25
Lower surface 26
Inner space 27
Cross frame member 28
Stabilising cross frame member 29
Channel cross section of base support frame 30
Side walls 30
Base walls 31
Inners space 32
Stabilizing beam and plates 33
Mast Frame 21
Elongate side members 35
Elongate end members 36
Inner space 37
Side members 35—channel cross section of mast frame 21
Side walls 40
Base 41 (oriented vertically as side of the mast)
Rod members 42
Bracket plate members 43
Cog wheel members 44
Mast Supporting Brace 45
Fixing brackets 46
Post member 47
Angle member—48
Vehicle mounting apparatus 49
Cantilevered elongate member 50
Plate member 51
Shelf member 52
Hydraulic lever mounting platform 53—see FIG. 3
Ram mounting bracket 54—as shown in FIGS. 3 and 9
Stabilizing Means 18
Leg ram members 55
Leg ram receiving member 56
Cage frame 57
Hydraulic lines 58
Mast seating pivot assembly 59
Seating ram member 60
Actuating Apparatus 7
Side walls 61
Roof 62
Base 63
Front wall 64
Rear wall 65
Cap 66
Power Supply Apparatus 9
Electric motor 70
Tank 71
Pump 72
Operating lever members 74
Flow control valve 75
Connecting means 76
Data logger 77
Computer—laptop 78
Valves 80
Battery 82
Side walls 84
Roof 85
Base 86
Front wall 87
Rear wall 88
On/off switch 92
E Stop 93
Mast ram member 94
Ram Receiving Member 95
Front plate member 100
Rear plate member 102
Spacer plate member 104
Carriage Hydraulic motor 106
Vehicle 122
Lever 111, 112, 113, 114, 115, 116
First end member fixing housing 130
Second end member fixing housing or coupling 132
Manually operated CBR apparatus 135
Load cell 137
CBR plunger 139
Cone penetrometer 140
Coring barrel 142
Split spoon sampler 144
Dutch Auger 146
Auger 148

1. A penetration testing apparatus for testing a bearing strength of at least one of ground, soil layers, base-courses, subbases or subgrades, comprising:
a frame support which supports an actuating apparatus, power supply apparatus, movable carriage assembly, ground penetrating member, carriage drive mechanism and ground stabilizer that are, operatively connected together to carry out a ground test;
the movable carriage assembly movably supports the ground penetrating member; and
the movable carriage assembly is movably supported by the frame support such that power from the actuating apparatus slidably and mechanically moves the carriage assembly up and down with the ground penetrating member, on a portion of the frame support, to cause the ground penetrating member to contact or penetrate the ground when the carriage assembly moves down and to be slidably moved back up the portion of the frame support to repeat the sliding down movement again without manual operation.

2. The penetration testing apparatus as claimed in claim 1 wherein, the frame support includes a base support frame comprising a planar frame horizontally oriented which supports a mast frame which is vertically oriented, and the carriage assembly includes a carriage slidably mounted on the mast frame whereby in use the carriage drive mechanism enables the carriage assembly to move up and down the mast frame.

3. The penetration testing apparatus as claimed in claim 2 wherein, the actuating apparatus is located and supported on the base support frame on one side of the mast frame, and the power supply apparatus is located on the other side of the mast frame on the base support frame.

4. The penetration testing apparatus as claimed in claim 1 wherein, the ground stabilizer comprises at least one hydraulic ram assembly which includes a leg ram member slidably received in a tubular ram receiving member located and supported on the base support frame and being operatively connected by the actuating apparatus to in use cause said leg ram member to downwardly extend to engage or abut a supporting surface to support and level the apparatus, and is configured to allow the vehicle to be raised which allows a mass of the vehicle to be utilized to push ground penetrating member, and a seating ram member that is adjustable and connected underneath to a cantilevered support member of the support frame, to ensure that the mast frame when set up to conduct a test is perpendicular to the ground subject to test or at an angle as required by an operator.

5. The penetration testing apparatus as claimed in claim wherein, the actuating apparatus includes an electric motor operatively connected to the power supply apparatus and the electric motor is operatively connected to a hydraulic pump and then to a hydraulic tank and levers to activate hydraulic lines are connected to the carriage assembly, and the electric motor, the tank, and the pump are located within an actuating housing and the actuating apparatus self cycles when in an on position whereby flow of hydraulic fluid is controlled through each of the at least one hydraulic ram and the hydraulic motor by the levers.

6. The penetration testing apparatus as claimed in claim 2 wherein, the mast frame is an elongate frame having ends, comprising side members connected to cross members including plate members located at the ends and moveable mounted rod members located in between the ends and between the sides members wherein the rod members include movable wheel cog members.

7. The penetration testing apparatus as claimed in claim 1 wherein, the carriage drive mechanism includes a flexible drive member including a chain link member movably mounted on cog wheel members within the mast frame.

8. The penetration testing apparatus as claimed in claim 1 wherein, the carriage assembly includes a carriage motor located on the carriage assembly and configured to cause the ground penetrating member to rotate, and the carriage assembly includes a front plate member, a spacer member and rear plate member together forming a member having side channels for sliding receipt in the side members of the mast support.

9. The penetration testing apparatus as claimed in claim 1 wherein, the actuating apparatus is an electrical actuating apparatus comprising linear actuators, electric switches, electric motors and drive units, and the linear actuators each have one of the electric motor connected to the power supply apparatus.

10. The penetration testing apparatus as claimed in claim 1 wherein, the actuating apparatus is a pneumatic actuating apparatus comprising an electric motor operatively connected to the rest of the components of the apparatus.

11. The penetration testing apparatus as claimed in claim 1 wherein, the actuating apparatus comprises an electric motor, the power supply apparatus includes at least one battery located inside a power supply housing and additional batteries that are storable on the vehicle to which the apparatus is attached, and the power supply apparatus includes an on/off switch and E stop which are operatively connected to the battery wherein the on/off switch controls a supply of power to the electric motor and the E stop functions to provide a safety cut out mechanism if required.

12. The penetration testing apparatus as claimed in claim 1 wherein, the carriage drive mechanism includes a mast ram apparatus which is operatively connected to the actuating apparatus which is a hydraulic actuating apparatus, and includes at least one mast ram member slidably received within a ram receiving member which are vertically oriented to cause the carriage assembly to move vertically up and down a mast frame of the frame support.

13. The penetration testing apparatus as claimed in claim 1 wherein, the actuating apparatus includes operating lever members, hydraulic valves and hydraulic lines to control movement of the ground stabilizer, the carriage drive mechanism, the carriage assembly, in two modes, including a standard mode allowing user controlled rate of travel and a detent mode which allows a controlled rate of movement independent of an operator accordingly, and the lever members are mounted on the mast frame.

14. The penetration testing apparatus as claimed in claim 13 wherein, the operating lever members includes first and second levers to operate the ground stabilizer, a third lever to operate the carriage assembly, fourth and fifth levers to calibrate controlled distal movement of the carriage assembly, and a sixth lever to control a forward and back adjustment of the mast assembly with a seating ram member wherein;
the first and second levers control separately or together, the ground stabilizer,
the third lever is operatively connected to a carriage hydraulic motor to provide rotational movement for drilling of the ground penetrating member,
the fourth lever is operatively connected to slidably move the carriage assembly up and down the mast frame in regard to speed control which allows for coarse control of the carriage assembly,
the fifth lever is operatively connected to the carriage assembly for controlled distance movement through a flow control valve or similar allows for controlled adjustment at a constant rate of travel, and
the sixth lever is operatively connected to the mast adjustment ram which allows the mast position to be adjusted to a perpendicular position when pushing the ground penetrating member or any other attachment into the ground.

15. The penetration testing apparatus as claimed in claim 1 wherein, the apparatus includes a support apparatus which includes a vehicle mounting apparatus which is removably and adjustably attached to a vehicle, the vehicle mounting apparatus includes at least one cantilevered elongate member extending rearwardly of a base support frame of the frame support and including a plate member which is vertically oriented and connectable to the vehicle.

16. The penetration testing apparatus as claimed in claim 1 wherein, the apparatus is mounted on a vehicle, a tracked unit, a tractor, or a trailer.

17. The penetration testing apparatus as claimed in claim 2 wherein, the base support frame includes a mast supporting brace which includes a post member and angle member, the post member is connectable to the mast support on a front side of the base support frame and being located parallel in orientation to the mast frame, and the angle member extends from a top of the post member outwardly rearwardly to an opposite side of the base support frame.

18. The penetration testing apparatus as claimed in claim 1 wherein, the carriage assembly includes at least one load cell and a first end member fixing housing and a second end fixing housing or coupling operatively connected together and to the power supply apparatus, configured to cause the ground penetrating member to be moved up and down on mast frame according to a defined downward load with the load being measurable by the load cell.

19. The penetration testing apparatus as claimed in claim 18, further comprising a data logger which connects an output of the load cell and a computer operating device to enable the computer operating device to control and measure results of the movement of the ground penetrating member, the computer operating device is a laptop or tablet computer and communicates by cable or wirelessly.

20. The penetration testing apparatus as claimed in claim 1 wherein, the ground penetrating member comprises at least one of an elongate ground penetrating member, a cone penetrometer, a coring barrel, a split spoon sampler, a Dutch auger, an auger or of a drilling or boring device for extracting a sample for observation or creating a hole or determining bearing strength.
